(19) United States
(12) Patent Application Publication
(10) Pub. No.: US 2023/0334542 A1
(43) Pub. Date: Oct. 19, 2023

(54) USED VEHICLE TRADING SUPPORT SYSTEM AND METHOD

(71) Applicant: TOYOTA JIDOSHA KABUSHIKI KAISHA, Toyota-shi Aichi-ken (JP)

(72) Inventor: Kyosuke TERADA, Toyota-shi Aichi-ken (JP)

(73) Assignee: TOYOTA JIDOSHA KABUSHIKI KAISHA, Toyota-shi Aichi-ken (JP)

(21) Appl. No.: 18/108,176

(22) Filed: Feb. 10, 2023

(30) Foreign Application Priority Data
Apr. 19, 2022 (JP) 2022-068810

(51) Int. Cl. G06Q 30/0601

(52) U.S. Cl. CPC G06Q 30/0601

(57) ABSTRACT

The used vehicle trading support system includes: a first confirmation unit configured to confirm whether or not a vehicle owner has an intention to disclose his/her own vehicle as a used vehicle that is likely to be sold; an information disclosure unit configured to disclose the vehicle information of the owned vehicle when the first confirmation unit confirms that the vehicle owner has an intention to disclose the vehicle information of the owned vehicle as a used vehicle; a notification unit configured to notify the vehicle owner of a purchase price desired by the purchase applicant when there is a purchase applicant who wishes to purchase the owned vehicle by browsing the disclosed vehicle information; and a second confirmation unit configured to confirm whether or not the vehicle owner is allowed to sell the owned vehicle from the vehicle owner who has received the notification of the desired purchase price.

### CROSS-REFERENCE TO RELATED APPLICATION

This application claims priority to Japanese Patent Application No. 2022-068810 filed on Apr. 19, 2022, incorporated herein by reference in its entirety.

### BACKGROUND

### 1. Technical Field

The present disclosure relates to a used vehicle trading support system and method for supporting trading of used vehicles.

### 2. Description of Related Art

A used vehicle distribution system including a server that supports trading transactions of used vehicles between an individual seller terminal and a buyer terminal is known (see, for example, Japanese Unexamined Patent Application Publication No. 2015-036843 (JP 2015-036843 A)). The server of the used vehicle distribution system includes business negotiation support means and delivery support means. The business negotiation support means supports business negotiations between the seller terminal and the buyer terminal based on registered used vehicle information for sale, seller information, used vehicle information for purchase, and buyer information. When an approach request is received from the seller terminal or the buyer terminal, the business negotiation support means transmits a business negotiation screen to the seller terminal and the buyer terminal to start the business negotiation. In the business negotiation screen, the seller and the buyer can exchange messages with each other. The delivery support means generates delivery request information and transmits the delivery request information to a partner terminal when the business negotiation between the seller and the buyer is established. The delivery support means requests the partner to carry out the procedure up to delivery.

### SUMMARY

In the used vehicle distribution system of the related art as described above, it is required for the seller to register the used vehicle information for sale and the seller information in the system. However, once the used vehicle information for sale or the like is registered in the system, the seller needs to conduct business negotiations all the time when there is a buyer. Therefore, the used vehicle distribution system of the related art described above is not always easy to use for a vehicle owner who thinks that the vehicle owned by the vehicle owner may be sold depending on conditions. Therefore, there is still room for improvement in usability of the vehicle owner who can become a seller.

Therefore, the present disclosure provides a technique for improving usability of the vehicle owner who can be a seller of a used vehicle and realizing smooth trading of the used vehicle.

A used vehicle trading support system according to the present disclosure is a used vehicle trading support system that supports trading of a used vehicle utilizing vehicle information acquired from a plurality of vehicles, and includes: a first confirmation unit that confirms with a vehicle owner whether the vehicle owner intends to disclose an owned vehicle as the used vehicle that has a possibility to be sold; an information disclosure unit that discloses the vehicle information of the owned vehicle when the first confirmation unit confirms that the vehicle owner intends to disclose the owned vehicle as the used vehicle; a notification unit that notifies the vehicle owner of a desired purchase price of a purchase applicant when there is the purchase applicant who desires to purchase the owned vehicle by browsing the vehicle information disclosed; and a second confirmation unit that confirms with the vehicle owner who is notified of the desired purchase price whether to sell the owned vehicle.

A used vehicle trading support method according to the present disclosure is a used vehicle trading support method for supporting trading of a used vehicle utilizing vehicle information acquired from a plurality of vehicles, and includes: confirming with a vehicle owner whether the vehicle owner intends to disclose an owned vehicle as the used vehicle that has a possibility to be sold; disclosing the vehicle information of the owned vehicle when the vehicle owner is confirmed to intend to disclose the owned vehicle as the used vehicle; notifying the vehicle owner of a desired purchase price of a purchase applicant when there is the purchase applicant who desires to purchase the owned vehicle by browsing the vehicle information disclosed; and confirming with the vehicle owner whether to sell the owned vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating a used vehicle trading support system according to an embodiment of the present disclosure; and

FIG. 2 is a flow chart illustrating a process of supporting a used vehicle trading by the used vehicle trading support system of the present.

### DETAILED DESCRIPTION OF EMBODIMENTS

Embodiments of the present disclosure will now be described with reference to the drawings.

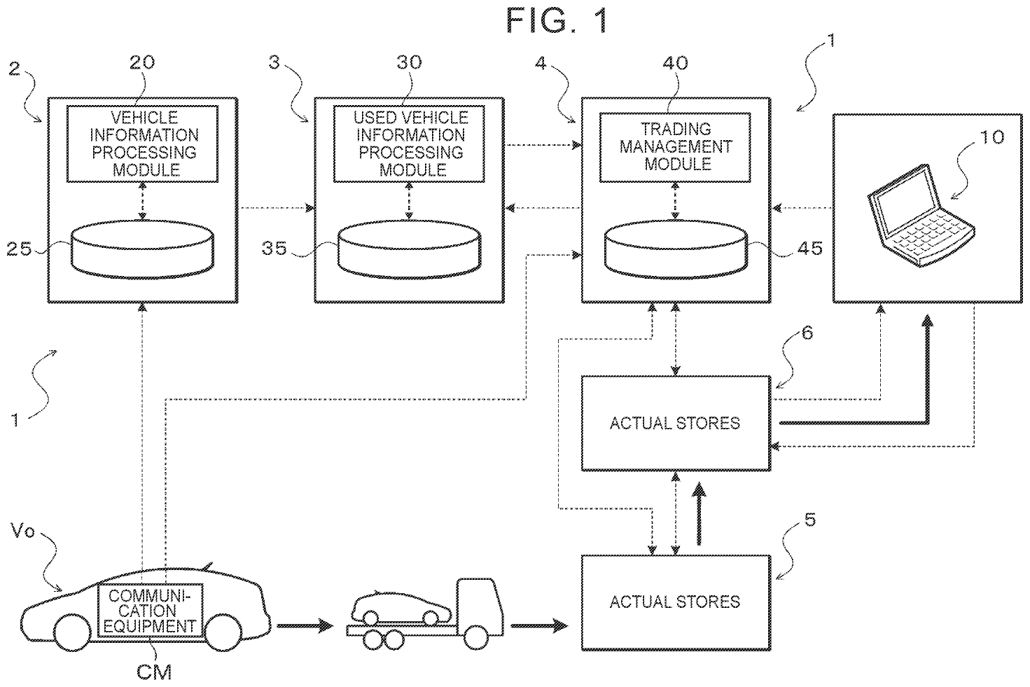

FIG. 1 is a schematic configuration diagram illustrating a used vehicle trading support system 1 according to the present disclosure. The used vehicle trading support system 1 shown in the figure is capable of matching a vehicle owner with a purchase applicant. Vehicle owners are considering the sale of their owned vehicle Vo. The purchase applicant wishes to purchase of the Owned Vehicles Vo. As illustrated in FIG. 1, the used vehicle trading support system 1 includes a vehicle information management server 2, a used vehicle information management server 3, and a used vehicle trading management server 4. The vehicle information management server 2 and the used vehicle information management server 3 can exchange information with each other via, for example, a network such as the Internet or a dedicated line. The used vehicle information management server 3 and the used vehicle trading management server 4 can exchange information with each other via, for example, a network such as the Internet or a dedicated line. Further, the used vehicle trading management server 4 is capable of exchanging information with a terminal or a server (not shown) installed in the actual stores 5, 6, which are dealers of a series of used vehicle dealers or dealers handling used vehicles, via a network such as the Internet or a dedicated line.

The vehicle information management server 2 is a computer including a CPU, ROM, RAM, an input/output device, a communication module, and the like. In the present embodiment, the vehicle information management server 2 is installed and managed by, for example, an automobile manufacturer. The vehicle information management server 2 includes a vehicle information processing module 20 and a storage device 25. The vehicle information processing module 20 is constructed by cooperation of hardware such as a CPU and a ROM,RAM and various programs installed in advance. The vehicle information processing module 20 acquires vehicle information from a plurality of vehicles registered in the vehicle information management server 2. The vehicle information processing module stores the acquired information in the storage device 25.

Vehicle information acquired from the vehicle that is applicable by the vehicle information processing module 20 includes, for example, the car number or vehicle identification number, the current vehicle owner name, contact point of the vehicle owner name, owner itinerancy, manufacturer name, vehicle name, model, year, model, body color, drive system, transmission type, handle position, displacement, fuel type, capacity, number of doors, body type, grade name, individual equipment, vehicle photograph, vehicle inspection presence or absence, ownership form, maintenance record, travel distance, accident history, body data, travel record, and other information such as travel records. Such vehicle information is acquired as big data from a plurality of vehicles in order to investigate a cause of a defect occurring in the vehicle, optimize specifications of parts and vehicle systems, analyze traffic flow, road surface conditions, behavior correction, and the like, and improve efficiency of a car sharing business.

The storage device 25 of the vehicle information management server 2 stores a database in which the vehicle information is stored for each of the plurality of vehicles. In other words, individual ID is assigned to each of the plurality of vehicles registered in the vehicle information management server 2. Vehicle-information is stored in a data base in association with ID. Further, the database is updated every time a new vehicle is registered in the vehicle information management server 2. Further, in the present embodiment, the vehicle information processing module 20 periodically requests the in-vehicle communication device CM (see FIG. 1) mounted in the vehicle such as the owned vehicle Vo to transmit the vehicle information. Based on the vehicle information transmitted from the in-vehicle communication device CM, the vehicle information processing module updates the data base.

Further, the vehicle information processing module 20 periodically transmits an information disclosure intention confirmation notification to the in-vehicle communication device CM of the vehicle registered in the vehicle information management server 2. The information disclosure intention confirmation notification is a notification for confirming whether or not the vehicle owner is willing to disclose owned vehicle Vo as a used vehicle that may be sold. When the vehicle owner confirms that the information disclosure intention confirmation notification is received, if the vehicle owner wants to sell the owned vehicle Vo or the vehicle owner considers that the owned vehicle Vo may be sold depending on the conditions, the vehicle owner can return (transmit) a reply (notification) to the vehicle information management server 2 that the vehicle owner agrees to the disclosure as a used vehicle with the possibility of selling the owned vehicle Vo. In addition, the vehicle owner can voluntarily transmit, from the in-vehicle communication device CM or the like, a notification indicating that the vehicle owner agrees to the disclosure of the owned vehicle Vo as a used vehicle, which may be sold, to the vehicle information management server 2 regardless of whether or not the notification is made from the vehicle information management server 2.

When the vehicle information processing module 20 (the vehicle information management server 2) receives a notification from the vehicle owner that the vehicle information processing module agrees to the disclosure as a used vehicle with the possibility of selling the owned vehicle Vo, the vehicle information processing module 20 transmits the vehicle information of the owned vehicle Vo to the used vehicle information management server 3. When the vehicle owner does not intend to sell the owned vehicle Vo when the vehicle owner confirms the reception of the information disclosure intention confirmation notification, the vehicle owner can prohibit the disclosure of the owned vehicle Vo by notifying the vehicle information management server 2 to that effect or ignoring the information disclosure intention confirmation notification. In addition, the information-disclosure intention confirmation notification may be transmitted not only to the in-vehicle communication device CM but also to, for example, the mail address of the registered vehicle owner.

The used vehicle information management servers 3 are computers including CPU, ROM, RAM, input/output devices, communication modules, and the like. In the present embodiment, the used vehicle information management server 3 is installed and managed by, for example, an automobile manufacturer. The used vehicle information management server 3 includes a used vehicle information processing module 30 and a storage device 35. The used vehicle information processing module 30 stores the vehicle information transmitted from the vehicle information management server 2 in the storage device 25. The used vehicle information processing module 30 is constructed in cooperation with hardware such as a CPU and a ROM, RAM and various programs installed in advance. Further, the used vehicle information processing module 30 acquires (collects) used vehicle information posted on used vehicle information sites of the company and other companies, and transaction information of used vehicles in a so-called auction. The used vehicle information management server 3 stores the acquired information together with the information on the sale and purchase established via the used vehicle trading support system 1. The storage device 35 of the used vehicle information management server 3 stores a vehicle information database in which the vehicle information is stored, and a market transaction price database in which the used vehicle information, transaction information, and information on trading established via the used vehicle trading support system 1 are stored.

Further, in response to reception of the vehicle information from the vehicle information management server 2, the used vehicle information processing module 30 calculates the reference residual value of the owned vehicle Vo that the vehicle owner is considering to sell, based on the received vehicle information and the information stored in the market exchange rate database. Further, the used vehicle information processing module (used vehicle information management server 3) calculates the reference residual value of the owned vehicle Vo, and then transmits the calculated reference residual value and the vehicle information of the owned vehicle Vo to the used vehicle trading management server 4.

The used vehicle trading management server 4 is a computer including a CPU, ROM, RAM, an input/output device, and a communication module. In the present embodiment, the used vehicle trading management server 4 is installed and managed by, for example, an automobile manufacturer. The used vehicle trading management server 4 includes a trading management module 40 and a storage device 45. The trading management module 40 is constructed by cooperation of hardware such as a CPU and a ROM, RAM and various programs installed in advance. The trading management module 40 manages the inventory of used vehicles to be sold, such as certified used vehicles and trade-in vehicles. In addition to the management of the used vehicle information website of the company, the trading management module 40 performs an intermediation process of trading the owned vehicle Vo that the vehicle owner is considering to sell.

The trading management module 40 of the used vehicle trading management server 4 receives, from the used vehicle information management server 3, the vehicle information and the reference residual value of the owned vehicle Vo that the vehicle owner is considering to sell. Thereafter, the trading management module 40 stores the received vehicle information and the reference residual value in the storage device 45. The trading management module 40 posts the owned vehicle Vo on the company's used vehicle information website as a sellable vehicle for a predetermined posting period (predetermined period). As a result, a large number of unspecified viewers can access the vehicle information and the like of the owned vehicle Vo of the used vehicle information website on a time-limited basis via a network such as the Internet. A purchase applicant who wishes to purchase the owned vehicle Vo can apply for purchase from his/her terminal 10 on the used vehicle information website to the used vehicle trading management server 4 and present a desired purchase price. The own terminal 10 is, for example, a personal computer or a smartphone. Then, the used vehicle trading support system 1 matches the vehicle owner who is considering the sale of the owned vehicle Vo with the purchase applicant who desires to purchase the owned vehicle Vo as described below.

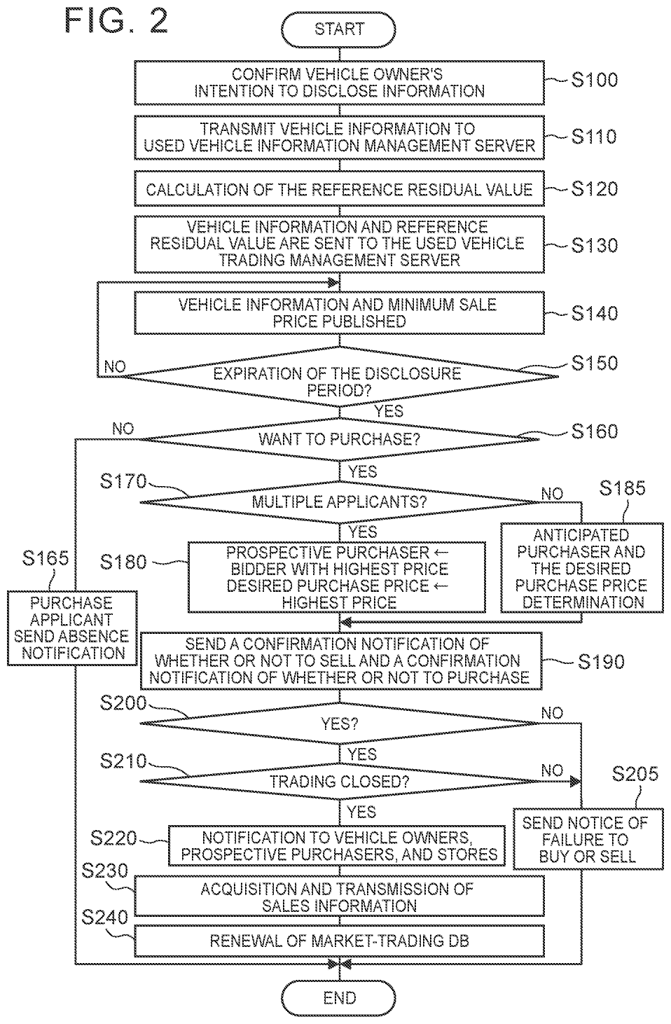

FIG. 2 is a flowchart illustrating a procedure for assisting a used vehicle trading by the used vehicle trading support system 1. The series of processing illustrated in FIG. 2 is executed in cooperation with the vehicle information processing module 20 of the vehicle information management server 2, the used vehicle information processing module of the used vehicle information management server 3, and the trading management module 40 of the used vehicle trading management server 4.

As shown in the drawing, the vehicle information processing module 20 receives, from the vehicle owner registered in the vehicle information management server 2, a notification indicating that the vehicle owner agrees to the disclosure as a used vehicle with the possibility of selling the owned vehicle Vo (step S100). Next, the vehicle information processing module 20 transmits the vehicle information of the owned vehicle Vo to the used vehicle information management server 3 (step S110). When the vehicle information is transmitted from the vehicle information management server 2 to the used vehicle information management server 3, the used vehicle information processing module 30 calculates the reference residual value of the owned vehicle Vo on the basis of the received vehicle information and information stored in the market exchange rate database (step S120).

In the step S120, the used vehicle information processing module 30 first acquires information (basic information) such as the age of the owned vehicle Vo, the travel distance, the degree of individual equipment (for example, the presence or absence of a genuine manufacturer option such as a sunroof), the presence or absence of a restoration history, the presence or absence of a maintenance notebook, and the condition of the interior and exterior from the vehicle information of the vehicle information management server 2. The used vehicle information processing module 30 calculates a base residual value from information to be acquired and a predetermined index. Further, in the step S120, the used vehicle information processing module 30 determines whether or not the target owned vehicle Vo is a popular vehicle in the market, a limited vehicle with a high demand, or an excessive vehicle in stock, based on the transaction results and the distribution status information in the market of the same vehicle type as the owned vehicle Vo stored in the market exchange rate database. The used vehicle information processing module 30 calculates an addition amount or a subtraction amount according to the determination result. Further, in the step S120, the used vehicle information processing module 30 determines, based on the information (health condition) such as the degree of restoration and the condition of the interior and exterior obtained from the vehicle information from the vehicle information management server 2, whether or not maintenance exceeding the standards is required in delivering the owned vehicle Vo to the next owner. The used vehicle information processing module 30 calculates a subtraction amount according to the determination result. Then, in the step-wise S120, the used vehicle information processing module 30 calculates a reference residual value by adding an addition amount or a subtraction amount based on a transaction result or the like in the market and a subtraction amount based on the health-state of the vehicle to the base residual value.

Subsequently, the used vehicle information processing module 30 transmits the vehicle information from the vehicle information management server 2 and the reference residual value calculated for the target owned vehicle Vo to the used vehicle trading management server 4 (step S130). When the vehicle information or the like is transmitted from the used vehicle information management server 3 to the used vehicle trading management server 4, the trading management module 40 creates a webpage of the target owned vehicle Vo on the basis of the vehicle information from the used vehicle information management server 3 and the reference residual value. The trading management module 40 posts web pages created on the company's used vehicle information website at intervals (step S140). In the step-wise S140, the reference residual value calculated by the used vehicle information processing module 30 is displayed on the web page as the lowest sale price of the owned vehicle Vo. As a result, a large number of unspecified viewers can access the vehicle information and the minimum sale price of the owned vehicle Vo disclosed on the used vehicle information web site for a limited period of time from when the web page of the owned vehicle Vo is posted on the used vehicle information website until the posting period (predetermined period) elapses (step S150: NO).

It is assumed that there is a purchase applicant who wants to purchase of owned vehicles Vo by browsing the vehicle information and the like disclosed on the used vehicle information website. The purchase applicant makes an application for purchase of the owned vehicle Vo from his/her terminal 10 to the used vehicle trading management server 4 on the used vehicle information website within the posting period. The purchase applicant may present the desired purchase price as well as the purchase offer. Further, in the present embodiment, when a plurality of purchase applicants appear within the posting period, the trading management module 40 notifies each purchase applicant of whether or not the highest price of the desired purchase price and the highest price are presented. As a result, the purchase applicant who wishes to purchase the owned vehicle Vo can present the desired purchase price exceeding the highest price to the used vehicle trading management servers 4. That is, in the used vehicle trading support system 1, the desired purchase price is determined in the auction format.

When the posting period elapses after the owned vehicle Vo is posted on the used vehicle information website (step S150: YES), the trading management module 40 determines whether or not there is a purchase applicant who wishes to purchase the owned vehicle Vo after the status of the owned vehicle Vo on the used vehicle information website is set to “under business negotiation” (step S160). When the trading management module 40 determines that there is no purchase applicant who wishes to purchase the owned vehicle Vo (step S160: NO), the trading management module 40 transmits a notification indicating that there is no purchase applicant who wishes to purchase the owned vehicle Vo to the in-vehicle communication device CM of the owned vehicle Vo, the e-mail address of the vehicle owner, or the like. Further, the trading management module 40 deletes the web page of the owned vehicle Vo from the used vehicle information web site (step S165). The trading management module 40 terminates the series of processes of FIG. 2 at that point in time. In this case, after the vehicle owner receives the notification from the trading management module 40, the vehicle owner notifies the vehicle information management server 2 again that the vehicle owner agrees to disclose the vehicle information or the like, or cancels the sale of the owned vehicle Vo.

On the other hand, when it is determined that there is a purchase applicant who wishes to purchase of owned vehicles Vo (step S160: YES), the trading management module 40 determines whether or not there are a plurality of purchase applicants who wish to purchase (step S170). When the trading management module 40 determines that the plurality of purchase applicants desire to purchase the owned vehicle Vo (step S170: YES), the trading management module 40 extracts the highest price of the desired purchase price presented by the plurality of purchase applicants. The trading management module 40 determines the purchase applicant who has presented the highest price as the prospective purchaser (next owner). The trading management module 40 determines the highest price as the desired purchase price of the prospective purchaser (step S180). In addition, when it is determined that there is one purchase applicant who wishes to purchase (step S170:NO), the trading management module 40 determines that the one person is to be purchased. In addition, the trading management module 40 determines the offer amount as the desired purchase price of the scheduled purchaser (step S185).

After the process of the step S180 or S185, the trading management module sets the reply time limit, and then transmits a notification (sale availability confirmation notification) for confirming whether or not the sale is possible to the vehicle owner, that is, the in-vehicle communication device CM of the owned vehicle Vo, or the like (step S190). The sellability confirmation notification includes the fact that there is a purchase applicant who wishes to purchase the owned vehicles Vo, and the desired purchase price. Further, in the step-wise S190, after setting the reply deadline, the trading management module 40 transmits a notification (purchase permission confirmation notification) for confirming the purchase permission to the prospective purchaser (e-mail address or the like). The purchase availability confirmation notification includes the fact that the purchase of the owned vehicles Vo is available and the desired purchase price. In addition, when there is a plurality of purchase applicants, the trading management module 40 transmits, in the step S190, a notification notifying the purchase candidates who have not become the purchase candidates that they have not become the purchase candidates that they have not become the purchase candidates.

The trading management module 40 determines whether or not a response from the vehicle owner and the planned purchaser has been received until the reply period elapses after sending the sale availability confirmation notification and the purchase availability confirmation notification (step S200). If the trading management module 40 determines that the response has not been received from either or both of the vehicle owner and the prospective purchaser by the response time limit (S200: NO), the trading management module 40 considers that the trading of the owned vehicle Vo between the vehicle owner and the prospective purchaser cannot be established. The trading management module 40 sends a notification to the vehicle owner and the planned purchaser that the trading of the owned vehicle Vo has not been established. The trading management module deletes the web page of the owned vehicle Vo from the used vehicle information web site (step S205). The trading management module 40 terminates the series of processes of FIG. 2 at that point in time.

In addition, when it is determined that an answer has been received from both the vehicle owner and the prospective purchaser (S200: YES), the trading management module 40 determines whether or not the vehicle owner agrees to sell the owned vehicle Vo and the prospective purchaser agrees to purchase the owned vehicle Vo (step S210). If the trading management module 40 determines that either the vehicle owner or the prospective purchaser does not agree to the sale or purchase of the owned vehicle Vo (step S210: NO), the trading management module 40 considers that the sale or purchase of the owned vehicle Vo between the vehicle owner and the prospective purchaser cannot be established. The trading management module 40 sends a notification to the vehicle owner and the planned purchaser that the trading of the owned vehicle Vo has not been established. The trading management module 40 deletes the web page of the owned vehicle Vo from the used vehicle information web site (step S205). The trading management module 40 terminates the series of processes of FIG. 2 at that point in time.

On the other hand, when the trading management module 40 determines that the vehicle owner agrees to sell the owned vehicle Vo and the prospective purchaser agrees to purchase the owned vehicle Vo (S210: YES), the trading management module 40 considers that the trading of the owned vehicle Vo is established between the vehicle owner and the prospective purchaser. The trading management module 40 selects the nearest actual store 5 in charge of the procedure with the vehicle owner and the nearest actual store 6 in charge of the procedure with the scheduled purchaser. Further, the trading management module 40 transmits a required notification to the vehicle owner, the planned purchaser, and the actual stores 5 and 6 (step S220). In S220 of steps, the trading management module 40 transmits a notification including the fact that the trade of the owned vehicle Vo is established to the vehicle owner (the in-vehicle communication device CM of the owned vehicle Vo or the like), the flow of the procedure in the actual store 5, and the like. The trading management module 40 transmits a notification to the prospective buyer (e-mail address or the like) including the fact that the trading of the owned vehicle Vo has been completed, the flow of the procedure at the actual store 6, and the like. Further, in S220 of steps, the trading management module 40 sends a notification including required information such as information about the vehicle owner or the scheduled purchaser, vehicle information on the owned vehicle Vo, and the desired purchase price to the terminals of the actual stores 5 and 6. In addition, in the step-by-step S220, the trading management module 40 deletes the web page of the owned vehicle Vo from the used vehicle information web site.

When the notification is transmitted to the related party in the step S220, a sales contract and delivery of the owned vehicle Vo are made between the vehicle owner and the actual store 5. The owned vehicle Vo is transported from the vehicle owner's home or the like to the actual store 6 through the actual store 5. During this time, necessary information is exchanged between the actual store 5 and the actual store 6 as appropriate. In addition, a sales contract for the owned vehicles Vo is made between the purchase applicant and the actual store 6. The owned vehicle Vo is delivered to the prospective purchaser after arriving at the actual store 6. After the delivery of the owned vehicle Vo to the prospective purchaser (new owner), the actual stores 5 and 6 transmit information regarding the sale of the owned vehicle Vo such as the sale price including the final expenses and the like to the used vehicle trading management servers 4. The trading management module 40 transmits the information acquired from the actual stores 5 and 6 to the used vehicle information management server 3 (step S230). Further, the used vehicle information processing module 30 of the used vehicle information management server 3 stores the information from the used vehicle trading management server 4 in the market transaction rate database in association with the vehicle information of the owned vehicle Vo (step S240). As a result, the owned vehicles Vo, that is, the trading of the used vehicles is completed under the support of the used vehicle trading support system 1.

As described above, in the used vehicle trading support system 1, the vehicle information processing module 20 of the vehicle information management server 2 as the first confirmation unit checks whether or not the vehicle owner has an intention to disclose his/her owned vehicle Vo as a used vehicle that may be sold. Further, when the vehicle information processing module 20 confirms that the vehicle owner has an intention to disclose the owned vehicle Vo as a used vehicle (S100), the trading management module 40 of the used vehicle trading management server 4 as an information disclosure unit discloses the vehicle information of the owned vehicle Vo (step S140, S150). Further, when there is a purchase applicant who wants to purchase the owned vehicle Vo by browsing the published vehicle information (step S160: YES, S170, S180, S185), the trading management module of the used vehicle trading management server 4 as the notification unit notifies the vehicle owner of the desired purchase price of the purchase applicant determined as the purchase scheduled person (step S190). Then, the trading management module 40 of the used vehicle trading management server 4 as the second confirmation unit confirms whether or not the owned vehicle Vo can be sold from the vehicle owner (step S200, S210).

Disclose vehicle info to explore the possibility and terms of purchase of the owned vehicle Vo owned by the company as used vehicles. Accordingly, the vehicle owner can determine whether or not to sell the owned vehicle Vo after knowing the desired purchase price of the planned purchase person (purchase applicant). That is, the vehicle owner uses the used vehicle trading support system 1 when he/she thinks that he/she may sell his/her owned vehicle Vo depending on the conditions. Accordingly, the vehicle owner can know the purchase terms (desired purchase prices) of the owned vehicle Vo without conducting business negotiations or the like. As a result, usability of a vehicle owner who can become a seller of a used vehicle can be improved. In addition, it is possible to realize smooth trading of used vehicles.

Further, in the used vehicle trading support system 1, the used vehicle information processing module 30 of the used vehicle information management server 3 functions as a residual value calculation unit (step S120). The residual value calculation unit calculates a reference residual value of the owned vehicle Vo based on at least the vehicle information transmitted from the vehicle information management server 2. Further, the trading management module 40 of the used vehicle trading management server 4 opens the reference residual value calculated by the used vehicle information management server 3 as the lowest sale price in addition to the vehicle information of the owned vehicle Vo (step S140,S150). As a result, the purchaser who can be the purchase applicant of the owned vehicle Vo, that is, the used vehicle can determine whether or not to indicate the intention of the purchaser based on the vehicle information and the minimum sale price (reference residual value). As a result, it is possible to improve usability of a purchase applicant who can become a buyer of a used vehicle. It is possible to realize smooth trading of used vehicles.

Further, the used vehicle information processing module 30 of the used vehicle information management server 3 as the residual value calculation unit calculates the reference residual value by considering the information on the transaction result and the distribution status in the market of the same vehicle type as the owned vehicle Vo stored in the market transaction price database (step S120). Accordingly, the reference residual value, that is, the minimum sale price, can be calculated more appropriately based on the popularity and the distribution volume of the owned vehicle Vo.

Further, the trading management module 40 of the used vehicle trading management server 4 as the information disclosure unit releases the vehicle information of the owned vehicle Vo by a predetermined posting period (predetermined period) (step S140, S150). The trading management module 40 determines whether or not a purchase applicant who wishes to purchase appears within the posting period. The trading management module also functions as a determination processing unit (steps S170, S180, S185) for determining the desired purchase price. Accordingly, it is possible to clarify the time period from the disclosure of the vehicle information of the owned vehicle Vo until the purchase condition (desired purchase price) of the owned vehicle Vo is found. Therefore, it is possible to further improve usability of a vehicle owner who can become a seller of a used vehicle.

Further, when there are a plurality of purchase applicants, the trading management module 40 of the used vehicle trading management server 4 as the determination processing unit extracts the highest price among the desired purchase prices presented by the plurality of purchase applicants (step S180). The trading management module 40 of the used vehicle trading management server 4 as the notification unit notifies the vehicle owner of the highest price as the desired purchase price of the scheduled purchaser (step S220). That is, by determining the desired purchase price in the auction format, the vehicle owner can be given the chance to sell the owned vehicle Vo at a higher price.

The used vehicle trading support system 1 includes a vehicle information processing module 20. The vehicle information processing module 20 acquires vehicle information from a plurality of vehicles and stores the acquired vehicle information in a database in order to investigate a cause of a defect occurring in the vehicle, optimize specifications of the components and the vehicle system, and the like. This makes it possible to explore potential used vehicles by effectively utilizing vehicle information acquired as big data, and to revitalize the used vehicle market and thus the new vehicle market.

However, the vehicle information may be acquired only for the purpose of buying and selling used vehicles. The functions of the vehicle information management server 2 (vehicle information processing module 20) may be integrated into the used vehicle information management server 3. Further, in the used vehicle trading support system 1, the function of the used vehicle information management server 3 (used vehicle information processing module 30) may be integrated into the vehicle information management server 2 or the used vehicle trading management server 4. Furthermore, the functions of the vehicle information management server 2, the used vehicle information management server 3, and the used vehicle trading management server 4 may be integrated into a single server. In addition, instead of the vehicle information management server 2 (vehicle information processing module 20), the used vehicle information management server 3 (used vehicle information processing module 30) may receive, from the vehicle owner, a notification indicating that the vehicle owner agrees to the disclosure as a used vehicle with the possibility of selling the owned vehicle Vo. In this case, the used vehicle information management server 3 (used vehicle information processing module 30) may request the vehicle information management server 2 (vehicle information processing module 20) to transmit the vehicle information of the owned vehicle Vo in response to the notification from the vehicle owner.

As described above, the used vehicle trading support system of the present disclosure is a used vehicle trading support system (1) that supports trading of used vehicles by utilizing vehicle information acquired from a plurality of vehicles, and includes a first confirmation unit (2, 20), an information disclosure unit (4, 40, step S140, step S150), a notification unit (4, 40, step S190), and a second confirmation unit (4, 40, step S200, step S210). The first confirmation unit (2, 20) checks whether or not the vehicle owner is willing to disclose his/her owned vehicle (Vo) as the used vehicle that may be sold. When it is confirmed by the first confirmation unit (2, 20) that the vehicle owner is willing to disclose the owned vehicle (Vo) as the used vehicle (S100), the information disclosure unit (4, 40, step S140, step S150) discloses the vehicle information of the owned vehicle (Vo). When there is a purchase applicant who wants to purchase the owned vehicle (Vo) by browsing the published vehicle information (step S160, step S170, step S180, step S185), the notification unit (4, 40, step S190) notifies the vehicle owner of the desired purchase price desired by the purchase applicant. The second confirmation unit (4, 40, step S200, step S210) checks whether or not the owned vehicle (Vo) can be sold from the vehicle owner who has received the notification of the desired purchase price.

The used vehicle trading support system of the present disclosure discloses the vehicle information of the owned vehicle when it is confirmed that the vehicle owner who confirms whether or not the vehicle owner is willing to disclose the owned vehicle as a used vehicle that may be sold is willing to disclose the owned vehicle as a used vehicle. Further, the used vehicle trading support system notifies the vehicle owner of the desired purchase price of the purchase applicant when there is a purchase applicant who wants to purchase the owned vehicle by browsing the disclosed vehicle information. Confirm whether or not to sell the owned vehicle owned by the vehicle owner. Make the vehicle information available to the public in order to find out the possibility and terms of purchase of the owned vehicle owned by the company as a used vehicle. As a result, the vehicle owner can determine whether or not to sell the owned vehicle after knowing the desired purchase price of the purchase applicant. That is, the vehicle owner utilizes the used vehicle trading support system of the present disclosure when he/she believes that he/she may sell his/her owned vehicle depending on conditions. As a result, the owner of the vehicle can know the purchase condition (desired purchase price) of the owned vehicle without conducting business negotiations or the like. As a result, usability of a vehicle owner who can become a seller of a used vehicle can be improved. It is possible to realize smooth trading of used vehicles.

In addition, the used vehicle trading support system (1) may include a residual value calculation unit (3, 30, step S120) that calculates a reference residual value of the owned vehicle (Vo) based on at least the vehicle information. In addition to the vehicle information of the owned vehicle (Vo), the information disclosure unit (4, 40) may disclose the reference residual value calculated by the residual value calculation unit (3, 30, step S120) as a minimum sale price (step S140, step S150). As a result, the purchase applicant who can be the buyer of the used vehicle can determine whether or not to manifest the intention of the purchaser based on the vehicle information and the minimum sale price (reference residual value). As a result, it is possible to improve usability of a purchase applicant who can become a buyer of a used vehicle. It is possible to realize smooth trading of used vehicles.

Further, the residual value calculation unit (3, 30) may calculate (step S120) the reference residual value by considering a transaction result and a distribution status in a market of the same vehicle type as the owned vehicle (Vo). As a result, it is possible to more appropriately calculate the reference residual value, that is, the minimum sale price, based on the popularity and the distribution amount of the owned vehicle in the market.

In addition, the information disclosure unit (4, 40) may step S140, step S150 the vehicle information of the owned vehicle (Vo) for a predetermined time. The used vehicle trading support system (1) may include a determination processing unit (4, 40, step S160, step S170, step S180, step S185) that determines whether or not the purchase applicant appears within the predetermined time period and determines the desired purchase price. This makes it possible to clarify the period from the disclosure of the vehicle information of the owned vehicle until the purchase condition (desired purchase price) of the owned vehicle is found. It is possible to further improve usability of a vehicle owner who can become a seller of a used vehicle.

Further, when there are a plurality of purchase applicants, the determination processing unit (4, 40) may extracts (step S180) highest price of the desired purchase prices presented by the plurality of purchase applicants. The notification unit (4, 40) may S190 the highest price to the vehicle owner. That is, by determining the desired purchase price in the auction format, it is possible to give the vehicle owner an opportunity to sell the owned vehicle at a higher price.

The used vehicle trading support system (1) may include a vehicle information processing unit (2, 20) that acquires the vehicle information from the plurality of vehicles and stores the vehicle information in a database. The vehicle information processing unit may acquire vehicle information from a plurality of vehicles in order to investigate a cause of a defect occurring in the vehicle, optimize specifications of the components and the vehicle system, and the like.

A used vehicle trading support method of the present disclosure is a used vehicle trading support method for supporting trading of a used vehicle by utilizing vehicle information acquired from a plurality of vehicles. It is confirmed whether or not the vehicle owner has an intention to disclose his/her own owned vehicle (Vo) as the used vehicle, and when it is confirmed that the vehicle owner has an intention to disclose the owned vehicle (Vo) as the used vehicle (step S100), the vehicle information of the owned vehicle (Vo) is disclosed (step S140, step S150), and when there is a purchase applicant who wants to purchase the owned vehicle (Vo), the desired purchase price of the purchase applicant is set as the vehicle owner A notification (step S190) is made to confirm whether or not the owned vehicle (Vo) can be sold (step S200, step S210).

According to such a method, it is possible to improve usability of a vehicle owner who can become a seller of a used vehicle, and to realize smooth trading of the used vehicle.

It is needless to say that the disclosure of the present disclosure is not limited to the above-described embodiments, and various modifications can be made within the scope of the extension of the present disclosure. Furthermore, the above embodiment is merely a specific form of the disclosure described in the column of the summary of the disclosure, and does not limit the elements of the disclosure described in the column of the summary of the disclosure.

The disclosure of the present disclosure can be used in a business of selling used vehicles and the like.

What is claimed is:

1. A used vehicle trading support system for supporting trading of a used vehicle utilizing vehicle information acquired from a plurality of vehicles, the used vehicle trading support system comprising:
a first confirmation unit that confirms with a vehicle owner whether the vehicle owner intends to disclose an owned vehicle as the used vehicle that has a possibility to be sold;
an information disclosure unit that discloses the vehicle information of the owned vehicle when the first confirmation unit confirms that the vehicle owner intends to disclose the owned vehicle as the used vehicle;
a notification unit that notifies the vehicle owner of a desired purchase price of a purchase applicant when there is the purchase applicant who desires to purchase the owned vehicle by browsing the vehicle information disclosed; and
a second confirmation unit that confirms with the vehicle owner who is notified of the desired purchase price whether to sell the owned vehicle.

2. The used vehicle trading support system according to claim 1, further comprising a residual value calculation unit that calculates a reference residual value of the owned vehicle based on at least the vehicle information, wherein the information disclosure unit discloses the reference residual value calculated by the residual value calculation unit as a lowest sales price, in addition to the vehicle information of the owned vehicle.

3. The used vehicle trading support system according to claim 2, wherein the residual value calculation unit calculates the reference residual value in consideration of a transaction result and a distribution status of a same vehicle model as the owned vehicle in a market.

4. The used vehicle trading support system according to claim 1, further comprising a determination processing unit that determines whether there is the purchase applicant within a predetermine period, and determines the desired purchase price, wherein the information disclosure unit discloses the vehicle information of the owned vehicle within a predetermined period.

5. The used vehicle trading support system according to claim 4, wherein:
when there is a plurality of the purchase applicants, the determination processing unit extracts a highest price from the desired purchase prices presented by the purchase applicants; and
the notification unit notifies the vehicle owner of the highest price.

6. The used vehicle trading support system according to claim 1, further comprising a vehicle information processing unit that acquires the vehicle information from the vehicles and stores the vehicle information in a database.

7. A used vehicle trading support method for supporting trading of a used vehicle utilizing vehicle information acquired from a plurality of vehicles, the used vehicle trading support method comprising:
confirming with a vehicle owner whether the vehicle owner intends to disclose an owned vehicle as the used vehicle that has a possibility to be sold;
disclosing the vehicle information of the owned vehicle when the vehicle owner is confirmed to intend to disclose the owned vehicle as the used vehicle;
notifying the vehicle owner of a desired purchase price of a purchase applicant when there is the purchase applicant who desires to purchase the owned vehicle by browsing the vehicle information disclosed; and
confirming with the vehicle owner whether to sell the owned vehicle.
